(19) United States
(12) Patent Application Publication
(10) Pub. No.: US 2005/0110337 A1
(43) Pub. Date: May 26, 2005

(54) Electronic pressure relief strategy

(76) Inventors: Yuhong Zheng, Ann Arbor, MI (US); Danny R. Milot, Ann Arbor, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/721,308

(22) Filed: Nov. 25, 2003

(51) Int. Cl. B60T 13/16

(52) U.S. Cl. 303/10; 303/116.1

(57) ABSTRACT

A method of controlling pressure in a fluid system having a source of pressurized fluid for which a maximum desired fluid pressure value has been determined, a hydraulic load, an apply valve controlling pressurized fluid flow between the source and the load, and a release valve permitting fluid flow from the load to a low pressure reservoir. Pressure is controlled at the hydraulic load by at least one of closing the release valve and opening the apply valve to increase pressure at the hydraulic load, and by at least one of closing the apply valve and opening the release valve to reduce pressure at the hydraulic load. Simultaneously, pressure of the source of pressurized fluid is limited by opening both the apply valve and the release valve from the positions required to control pressure at the hydraulic load a sufficient amount to permit pressurized fluid from the source of pressurized fluid to flow through the apply valve and the release valve to the low pressure reservoir at a flow rate sufficient to limit pressure of the source of pressurized fluid to less than the maximum desired fluid pressure value.

### BACKGROUND OF THE INVENTION

This invention relates in general to fluid systems, and in particular to a system for controlling pressure at a load in a hydraulic system having an apply valve selectively connecting a source of pressurized fluid to a hydraulic load and a release valve for venting pressurized fluid from the hydraulic load, and includes a system to relieve an overpressure condition in the source of pressurized fluid. One example of such a fluid system is an electrohydraulic braking system.

Traditional hydraulic brake systems include a brake pedal operated by the driver of a vehicle. The brake pedal operates a master cylinder, causing the master cylinder to send pressurized hydraulic brake fluid to the wheel brakes of a vehicle. This is sometimes referred to as foundation or base braking—the basic braking called for by the operator of a vehicle. Over the years, engineers have worked to improve the performance of the braking system of vehicles by augmenting or replacing the base braking function with another braking operation.

As used in herein, electrohydraulic brake (EHB) systems mean any brake system utilizing electronically controlled valves, pumps, or a combination thereof to augment, replace, or control the braking operation of a vehicle brake system. Note that the meaning used herein is broader than may be typically understood by those in the automotive industry. One of the first of many advanced braking functions that has been developed for vehicles is Antilock Braking System (ABS), which typically involves the operation of valves and pumps to selectively release and re-apply brakes during a braking operation. While typical base braking is commanded by the operator, ABS braking electronically controls the vehicle brakes to recover from and limit skidding of a vehicle's wheels due to braking the wheels harder than permitted by the available coefficient of friction of the road surface. Since pumps and valves are electronically controlled to augment the base braking operation, a vehicle equipped with ABS may generally be said to have an EHB system. Another advanced braking function that may be accomplished by a properly configured EHB system is Vehicle Stability Control (VSC), which is a system for selectively actuating vehicle brakes to improve the stability of a vehicle during vehicle maneuvers. Other advanced braking applications producing a pressure command input to an EHB system include: Dynamic Rear Proportioning (DRP—a system for controlling the front to rear proportioning of a vehicle braking command); Traction Control (TC—which typically involves selective application of brakes during vehicle acceleration to recover from and limit skidding of a vehicle's wheels due to accelerating the wheels faster than permitted by the available coefficient of friction of the road surface); and Autonomous Cruise Control (ACC—a cruise control system that can actuate vehicle brakes to maintain proper vehicle spacing relative to a vehicle in front) and similar functions.

Various forms of EHB systems have been proposed. For example U.S. Pat. No. 5,941,608 to Campau et al. (hereinafter “the '608 patent”) discloses an Electronic Brake Management (EBM) system with manual fail-safe capabilities. The disclosures of the '608 patent are hereby incorporated by reference. The EBM system of the '608 patent is an EHB system. In such an EBM system, braking can be primarily controlled by the vehicle driver. Additionally, an electronically controlled portion of the system can operate the brakes automatically under certain conditions to implement such features as anti-lock braking, traction control, etc. Normally, the vehicle driver or a safety system generates an electronic signal, which in turn operates pump(s) and valve(s) to achieve a braking pressure within the system. A pedal simulator and master cylinder cooperate to create the effect for the driver of applying direct braking pressure while also providing a back-up braking system in case of a failure of the primary system.

In the EBM system of the '608 patent, as well as in many other EHB systems, there are a series of valves in the hydraulic circuit that operate to apply pressure to or release pressure from the brake. The pressure is supplied from a hydraulic pump. In one embodiment of the '608 patent, proportional control valves are provided for each vehicle brake. In a first energized position, an apply position, the proportional control valve directs pressurized hydraulic fluid supplied to the proportional control valve to an associated fluid separator unit via a valve port. The pressure is transmitted through the fluid separator unit (which may be embodied as a piston sliding in a cylinder) to an associated vehicle wheel brake. In a second energized position, the maintain position, the proportional control valve closes off the port thereof which is in communication with the associated fluid separator unit, thereby hydraulically locking the associated fluid separator piston of the fluid separator unit in a selected position and keeping pressure at the associated wheel brake constant. In a de-energized position, the release position, the proportional control valve is moved by a spring to a position where the proportional valve provides fluid communication between the associated fluid separator unit and a reservoir. This vents pressure from the associated fluid separator unit allowing the piston thereof to move back to an non-actuated position under the urging of an associated spring, thereby reducing pressure at the associated wheel brake. The positions of the proportional control valves are controlled such that the position of the valve and thus the pressure of fluid in the hydraulic circuit is controlled proportionally to the current of the energizing electrical signal. Thus, the proportional control valves can be positioned at an infinite number of positions (throttled).

As taught in the '608 patent with respect to FIG. 10 thereof, separate apply valves (valves 70a and 70b in the '608 patent) and release valves (valves 72a and 72b in the '608 patent) can be substituted for a proportional spool valves such as those illustrated in FIG. 1 of the '608 patent for controlling pressure at the brake calipers of a vehicle. When pressure is commanded to rise at an associated wheel brake, an apply valve is opened to supply of pressurized a brake fluid from a source of high pressure brake fluid through an apply path to the wheel brake, while the release valve is shut, blocking a release path from the wheel brake to a fluid reservoir. When pressure is commanded to be held constant at the brake, the apply and the release valves are shut, blocking both the apply and release paths. When pressure is commanded to be decreased at the brake, the apply valve is shut to close the apply path and the release valve is opened to relieve pressurized brake fluid from the associated brake back to the fluid reservoir via the release path. The apply and release valves may have two commanded positions, fully open and fully closed (such valves are sometimes called “digital” valves) or may be proportionally controlled valves able to also be positioned at an infinite number of intermediate positions between fully open and fully closed. Examples of some suitable proportional valves included spool valves and proportional poppet valves.

As in all things man-made, there is the potential for a malfunction within an EHB system. For example, a control failure could result in the pump being improperly controlled, resulting in an excessive pressure within the associated discharge piping and components connected to the piping, such as an associated high pressure accumulator. Indeed, even without a malfunction, an increase in fluid temperature (due to changes in ambient temperature, for example) could also cause the pressure in the accumulator or other system components containing trapped volumes of hydraulic brake fluid to increase to unacceptable levels. Such increases in pressure should be alleviated in order to prevent a failure of or damage to (including excessive wear) system components, such as the pump, the accumulator, or valves.

In the past, a relief valve has been provided to relieve such overpressure conditions in EHB systems. Such relief valves were typically a spring closed valve which opened when pressure at the inlet of the valve created an opening force sufficient to overcome the spring force holding the valve shut.

U.S. Pat. No. 6,189,982 to Harris et al. (hereinafter “the '982 patent”), the disclosure of which is incorporated herein by reference, discloses in FIG. 2 thereof an EHB system with a hydraulic pressure source consisting of a hydraulic accumulator adapted to be charged by a pump. The accumulator and pump are both in fluid communication with the apply valves of the EHB system. The accumulator is provided with a solenoid-operated accumulator isolating valve which, in a first position of the accumulator isolating valve, fluid flow is permitted in both directions through the accumulator isolating valve. In a second position, the accumulator isolating valve acts as a one-way valve preventing fluid flow from the accumulator to the apply valves or the pump, while permitting fluid flow from the pump into the accumulator. This arrangement reduces leakage from the accumulator through the various other components of the system, but raises the possibility of over-pressurization of the accumulator due to, for example, ambient temperature increases while fluid is stored in the accumulator. Accordingly, a relief valve 35 is provided which is continuously in communication with the accumulator.

### SUMMARY OF THE INVENTION

This invention relates to a pressure relief control strategy for an electrohydraulic braking system that provides overpressure protection for the system without the use of a dedicated relief valve. The apply and release paths of the EHB system can be controlled by the pressure relief strategy to distribute brake fluid within the brake circuit, including the pump discharge piping and the components connected thereto, to the wheel brakes and to the reservoir, maintain control of pressure at the brakes of the vehicle so that the desired brake pressure is maintained, while additionally providing a flow path through the apply and release paths of the system to overpressure protection for the system.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a simplified schematic view of a single circuit of an electro-hydraulic vehicle braking system using separate apply and release valves.

FIG. 2 is a view similar to FIG. 1, with the valves aligned to provide overpressure protection when pressure at the wheel brake is held constant.

FIG. 3 is a view similar to FIG. 1, with the valves aligned to provide overpressure protection when pressure at the wheel brake is being increased.

FIG. 4 is a view similar to FIG. 1, with the valves aligned to provide overpressure protection when pressure at the wheel brake is being decreased.

FIG. 5 is a view similar to FIG. 1, except having a second pressure controller.

### DETAILED DESCRIPTION OF THE PREFERRED EMBODIMENT

Preliminarily, it should be noted that when it is stated below that a first pressure “at least equals” a second pressure or a pressure set-point, that means that the first pressure can equal the second pressure or the set-point. The first pressure can also have a higher pressure than the second pressure or the set-point.

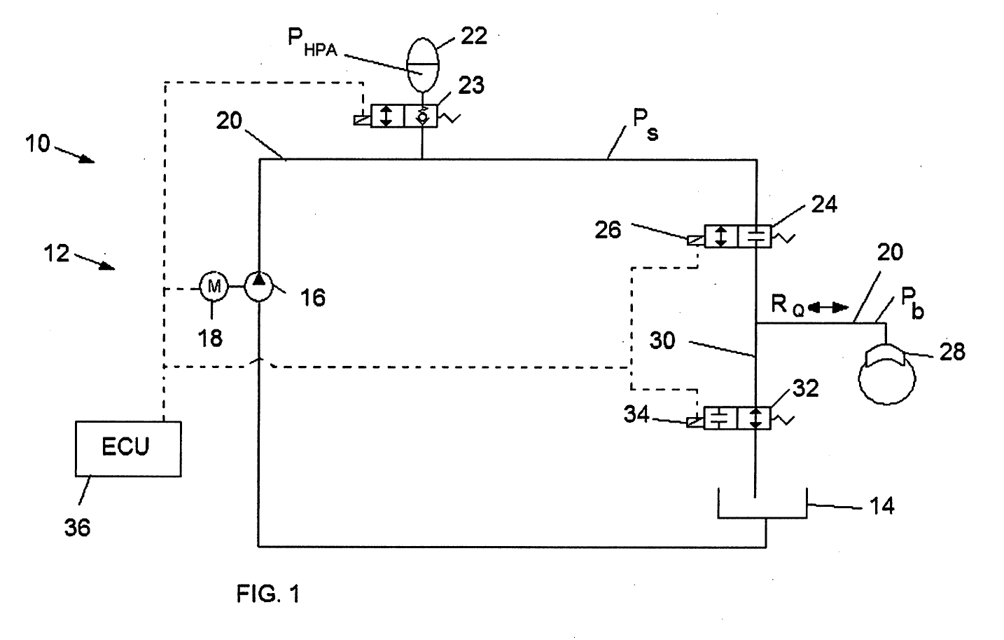

Referring now to the drawings, there is illustrated in FIG. 1 a greatly simplified schematic representation of a typical EHB system 10, illustrating a single simplified hydraulic circuit, together with a simplified diagram of the associated electronic braking signal processing circuitry, in which a pressure relief strategy according to the present invention is implemented. The simplified EHB system 10 includes a hydraulic circuit 12 having a hydraulic brake fluid low pressure reservoir 14. A pump 16 (operated by a motor 18) pumps hydraulic brake fluid from the reservoir 14 and supplies pressurized hydraulic brake fluid into a fluid conduit 20. The fluid conduit 20 is in communication with a high pressure accumulator (HPA) 22, via an HPA isolation valve 23, and with an apply valve 24.

The HPA 22 acts conventionally, storing a volume of pressurized hydraulic brake fluid during periods when the pump 16 is supplying hydraulic fluid into the conduit 20 at a greater rate than the fluid is passing through the apply valve 24, and supplying pressurized hydraulic fluid from this stored volume (if any exists) when the flow of fluid through the apply valve 24 exceeds the flow from the pump 16 into the conduit 20. The HPA 22 may be of any suitable design, and indeed, may suitably be omitted if the design criteria for the desired application of the system 10 permit. Similarly, the HPA isolation valve 23 may be of any suitable design, including normally open (as illustrated) or normally closed as required to achieve design objectives for a particular application. In many applications, the HPA isolation valve 23 may be omitted, in which case pressure P_{HPA} in the HPA 22 will equal supply pressure Pₛ in the conduit 20 upstream of the apply valve 24.

The pump 16 (and the HPA 22 if a stored volume of pressurized fluid is contained therein) acts as a source of pressurized hydraulic brake fluid for the rest of the system 10.

The apply valve 24 is preferably implemented as a normally closed poppet valve operated by a solenoid 26 in response to an electrical command signal, but may be any suitable valve responsive to a command signal (electrical, pneumatic, or other suitable command signal), such as a spool valve. When the apply valve 24 is opened, pressurized hydraulic brake fluid from the pump 16 and the HPA 22 passes through the apply valve 24 and flows through the conduit 20 to a hydraulic load in the form of a vehicle wheel brake 28. This flow path through the apply valve 24 defines the apply path of the hydraulic brake circuit 12 of the EHB system 10.

A fluid conduit 30 is connected to the conduit 20 between the wheel brake 28 and the apply valve 24, and provides a return path for hydraulic brake fluid from the wheel brake 28 to the reservoir 14. A normally open release valve 32 is disposed in the fluid conduit 30, and is operated by a solenoid 34, to control the flow of hydraulic brake fluid through the fluid conduit 30. The release valve 32 is preferably implemented as a normally open poppet valve operated by the solenoid 34 in response to an electrical command signal, but may be any suitable valve, such as a spool valve, responsive to a command signal (electrical, pneumatic, or other suitable command signal). This flow path through the release valve 30 defines the release path of the hydraulic brake circuit 12 of the EHB system 10.

It should be noted that the illustrated EHB system 10 is a simplification of what an actual braking system installed on a vehicle might contain. For example, the provision of a redundant method of applying the brakes of a vehicle on which the EHB system 10 might be installed is not illustrated. An example of such a redundant method of applying brakes might be the additional provision of an electrically-, pneumatically-, or spring-operated friction brake mechanism, or the provision of a push-through mode, such as that shown in the '608 patent (U.S. Pat. No. 5,941,608), which would allow operation of the hydraulic wheel brake 28 directly by a manually operated master cylinder in the event that an electrical failure prevented operation of the apply valve 24, the release valve 32 or the motor 18.

A controller 36 can use various input signals, such as a demanded braking signal or feedback signals, to control the operation of the solenoid 26 of the apply valve 24 and the solenoid 34 of the release valve 32 in order to control the flow of brake fluid into and out of the wheel brake 28. The controller 36 operates according to a predetermined control law to calculate a demanded brake pressure, P_{d}, needed to achieve the desired braking effect, and to operate the components of the EHB system 10 to achieve the demanded brake pressure P_{d}.

A plurality of sensors (not shown) can be provided in the EHB system 10 to monitor several system parameters. For example, this embodiment of the invention could include a sensor detecting pressure in the HPA 22 (HPA pressure P_{HPA}, which, if the HPA is not isolated from the rest of the EHB system 10 by the HPA isolation valve 23 would be equal to the pressure of the hydraulic brake fluid supplied to the apply valve, the supply pressure, Pₛ), temperature of the fluid in the HPA 22 (HPA fluid temperature, Tₕₚₐ), pump motor sensors, flow sensors, the amount of pedal travel, master cylinder pressure and sensors for detecting any other desired parameter or other operating characteristic, to achieve the demanded brake pressure P_{d} while providing overpressure protection according to the invention. Feedback to the controller 36 from sensors will allow the pump 16, the HPA isolation valve 23, the apply valve 24 and the release valve 32 to be precisely controlled to maintain a steady flow.

In normal operation, a brake apply signal is generated, either from sensors measuring parameters indicative of a driver's braking demand or automatically in response to predetermined conditions. Exemplary parameters which may be used alone or in combination to indicate a driver's braking demand include the distance a brake pedal (not shown) is depressed, the force with which the driver depressed the brake pedal, the resultant distance a master cylinder piston (not shown) is displaced, or the resulting pressure in the master cylinder. Exemplary conditions which might generate an automatic braking demand (that is, without the driver stepping on the brake pedal to command braking pressures at a particular level) include detection of a spinning driving wheel (traction control), detection of a skidding wheel (in this case, as a result of excess braking pressure applied under driver control, the automated system would act to lower brake pressure, e.g., ABS), or other conditions in which braking could be desirable in conjunction with such advanced vehicular control systems as advanced cruise control, collision avoidance, or integrated chassis control, which may include vehicle stability control—VSC. The brake apply signal or signals—there may be more than one, for example, a brake apply signal generated indicating driver demand, and a brake apply signal received from the VSC system—received by the controller 36 are interpreted in accordance with a control law to determine which components of the EHB system 10 are to be operated, and in what manner these components are to be operated.

According to one exemplary control scheme that may be used in the EHB system 10, when a brake apply signal is initially generated by the driver or automatically, the controller 36 determines that the wheel brake pressure P_{b} at the wheel brake 28 is less than the demanded brake pressure P_{d}, calculates an estimated amount of brake fluid Q which has to be added to the wheel brake 28 to raise the wheel brake pressure P_{b} at the wheel brake 28 to equal the demanded brake pressure P_{d}, and determines a desired rate of brake fluid flow R_{Q} into the wheel brake 28 to bring the wheel brake pressure P_{b} to equal the demanded brake pressure P_{d} with a desired rate of change in the wheel brake pressure P_{b} (rate of response). The desired rate of change in the wheel brake pressure P_{b} will be dependent upon various factors but in general, the greater the difference between the demanded brake pressure P_{d} and the wheel brake pressure P_{b}, the greater the desired rate of change in the wheel brake pressure P_{b}. The wheel brake pressure P_{b} may be either directly measured by a pressure sensor (not shown) at the wheel brake 28 or inferred from other parameters (such as vehicle speed, wheel speed, supply pressure Pₛ, etc.). The controller 36 shuts the release valve 32 by energizing the solenoid 34 and opens the apply valve 24 an amount that is calculated to achieve the desired rate of brake fluid flow R_{Q} given the difference between the supply pressure Pₛ and the wheel brake pressure P_{b}. As pressurized brake fluid flows out of the HPA 22, through the apply valve 24 and into the wheel brake 28, the HPA pressure P_{HPA} drops, and the controller 36 will energize the motor 18 to run the pump 16 as necessary to restore pressure in the HPA 22. The controller 36 continuously adjusts the signal to the apply valve solenoid 34 as the wheel brake pressure P_{b} approaches the demanded brake pressure P_{d}, to account for changes in the wheel brake pressure P_{b}, any changes in the supply pressure Pₛ, and so that the apply valve 24 closes (the solenoid 34 is deenergized) when the wheel brake pressure P_{b} equals the demanded brake pressure P_{d}. The apply valve 24 and the release valve 32 generally remain shut to hold the wheel brake pressure P_{b} constant as long as the wheel brake pressure P_{b} is equal to the demanded brake pressure P_{d}(except to implement the feature of the over-pressure relief strategy of the invention, as will be described below).

When the brake apply signal generated by the driver or automatically is reduced, for example, by the driver reducing pressure on the brake pedal, the controller 36 determines that the wheel brake pressure P_{b} at the wheel brake 28 is greater than the demanded brake pressure P_{d}, calculates an estimated amount of brake fluid Q which has to be removed to the wheel brake 28 to lower the wheel brake pressure P_{b} at the wheel brake 28 to equal the now lower demanded brake pressure P_{d}, and determines a desired rate of brake fluid flow R_{Q} out of the wheel brake 28 to bring the wheel brake pressure P_{b} to equal the demanded brake pressure P_{d} with a desired rate of change in wheel brake pressure P_{b}. The controller 36 leaves the apply valve 24 shut (by leaving the solenoid 26 deenergized) and opens the release valve 32 by decreasing the energizing signal to the solenoid 34 an amount that is calculated to achieve the desired rate of brake fluid flow R_{Q} given the difference between the wheel brake pressure P_{b} and the pressure in the reservoir 14. The reservoir 14 is vented to atmosphere, and is sufficiently large to receive all the fluid from the wheel brake 28 without pressurizing, so the pressure in the reservoir 14 will remain zero (atmospheric pressure) at all times. Therefore, the controller 36 does not actually perform a comparison of wheel brake pressure P_{b} and reservoir pressure, but rather bases the control signals to the components of the EHB system 10 based on the wheel brake pressure P_{b} (P_{b}−0=P_{b}) when relieving pressure to the reservoir 14. The controller 36 continuously adjusts the signal to the apply valve solenoid 34 as the wheel brake pressure P_{b} approaches the demanded brake pressure P_{d}, to account for changes in the wheel brake pressure P_{b} and so that the release valve 32 closes when the wheel brake pressure P_{b} equals the demanded brake pressure P_{d}.

If the braking signal is removed entirely (e.g., the driver takes his or her foot off of the brake pedal, and no automatically generated brake signal is present), the apply valve solenoid 26 is deenergized so that the apply valve 24 shuts (except as required to implement the feature of the over-pressure relief strategy of the invention, as will be described below), and the release valve solenoid 34 is deenergized so that the release valve 32 opens.

The above discussed control scheme for controlling the components of the EHB system 10 is one of many controls schemes that may be suitable for controlling wheel brake pressure P_{b} to achieve a demanded amount of braking. The control scheme to be used depends on various design criteria of performance, safety, cost, etc. As discussed above, for example, in some embodiments of EHB systems the apply valve is normally open and the release valve is normally closed, which would require some differences in the way the control scheme operates. These various schemes can further include various enhancements. An exemplary enhancement would be a temperature model that recognize that after braking occurs, the brake pads of the wheel brake 28 heat up and become less effective. The controller 36 would thus increase the demanded brake pressure P_{d} above the demanded brake pressure P_{d} that would be commanded with “cold” brake pads to achieve the same demanded amount of braking with “hot” brake pads. Additionally, EHB systems for motor vehicles are more complex than the simplified EHB system 10 illustrated, with additional components, and the control scheme to be utilized would account for this fact. For example, in some EHB systems in the prior art, it is possible to open an cross-tie (equalizing) valve to provide fluid communication between two wheel brakes at opposite ends of a vehicle axle, thereby equalizing pressure in the two wheel brakes in order to prevent yaw being induced in a vehicle from unequal braking at the two ends of the axle. The control scheme of such EHB systems may take into account the use of this cross-tie valve to achieve a desired wheel brake pressure P_{b} at a wheel brake even if the apply valve associated with that particular wheel brake is failed shut by supplying brake fluid through the cross-tie valve. All of this is to say that it is recognized that various control schemes for EHB systems are known, and can be provided with various enhancements. The invention described below can be readily implemented in control schemes other than the control scheme described above, and the scope of the invention is not limited to use with only the above described EHB control scheme.

As discussed in the Background Of The Invention section above, conventionally, hydraulic systems are provided with a relief valve to prevent damage to components from an over-pressure condition. For example, in the '608 patent (U.S. Pat. No. 5,941,608) includes relief valve 44 providing over-pressure protection for the normal source 4 (the pump-supplied source of pressurized brake fluid).

An electronic pressure relief strategy according to the present invention preferably includes measuring, sensing or estimating the pressure, P_{HPA}, in the HPA 22, (directly or indirectly using any suitable sensing mechanism) and using the controller 36 to compare the P_{HPA} pressure to a predetermined safety pressure set-point, Pₛₑₜ. In embodiments of the EHB system 10 in which the HPA isolation valve 23 is provided, if the P_{HPA} pressure is equal to or higher than the Pₛₑₜ pressure, the controller 36 operates to open the HPA isolation valve 23. If the pump 16 is operating, the controller 36 acts to stop the motor 18, to prevent pressure from rising further. If no braking signal is present, the release valve 32 is open, but the apply valve 24 is closed, preventing the pressure in the HPA 22 from being vented to the reservoir 14. Therefore, the controller 36 causes the apply valve 24 to be opened, establishing a pressure relief path from the accumulator 22 through the apply path and the release path of the EHB system 10. Preferably, the controller 36 will only partially open at least one of the HPA isolation valve 23 and the apply valve 24 to provide a controlled flow of fluid from the HPA 22 to prevent depressurizing the HPA 22 more than desired. When the pressure in the HPA 22 is reduced back down below the set-point pressure Pₛₑₜ, the controller 36 shuts the HPA isolation valve 23 and the apply valve 24. Preferably, the controller 36 will not shut the HPA isolation valve 23 and the apply valve 24 until the pressure in the HPA 22 has decreased some predetermined margin below the set-point pressure Pₛₑₜ to prevent rapid repeated cycling of these valves, much like a mechanical pressure relief valve (safety valve) will normally provide some blow-down below the opening set-point pressure thereof.

If the HPA 22 is not provided with an isolation valve 23, the operation of the controller 36 will be similar, except, of course, the controller 36 will not have to open the HPA isolation valve 23 to establish a pressure relief path to relieve pressure from the HPA 22 to the reservoir 14.

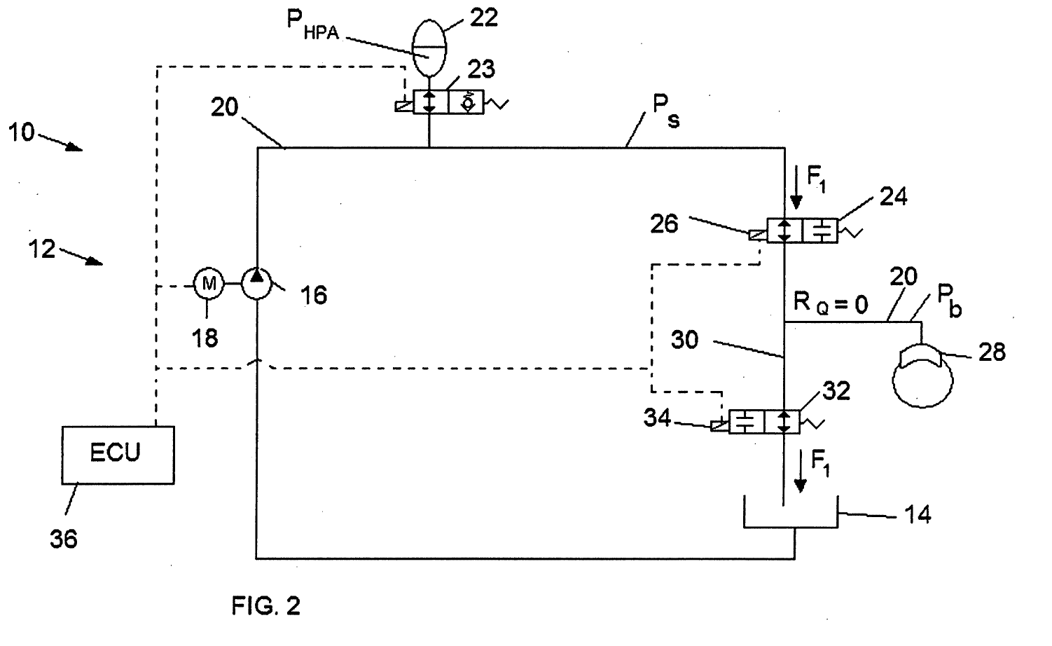

Next, referring to FIG. 2, consider a case where a braking signal is present. If the wheel brake pressure P_{b} is equal the demanded brake pressure P_{d}, then the brake fluid flow rate R_{Q} is equal to zero, that is, no brake fluid should flow into or out of the wheel brake 28. The apply path through the apply valve 24 and the release path through the release valve 32 are both closed to hold the desired amount of brake fluid in the wheel brake 28. If pressure in excess Of Pₛₑₜ is determined to exist in the HPA 22, the HPA isolation valve 23 is opened to connect the HPA 22 to the conduit 20. In order to relieve the excessive pressure in the conduit 20, the apply valve 24 is opened to permit an appropriate pressure relieving flow rate of brake fluid, F, to reduce the supply pressure Pₛ in the conduit 20 to below the set-point pressure Pₛₑₜ. Suitably the magnitude of the pressure relieving flow rate F, will increase dependent upon the degree to which the HPA pressure P_{HPA}, and thus the supply pressure Pₛ, exceeds the set-point pressure Pₛₑₜ. Simultaneously, the release valve 32 is opened sufficiently to pass the same flow rate F₁ of brake fluid through the release path that is flowing through the apply path. Since the flow rate through the release path is the same as through the apply path, the amount of brake fluid Q in the wheel brake 28 remains constant, and therefore the pressure P_{b} at the wheel brake 28 will remain constant at the demanded brake pressure P_{d}.

The controller 36 will monitor and control the wheel brake pressure P_{b}, and as the wheel brake pressure P_{b} starts to rise as a result of opening the apply valve 24 to vent the overpressure condition in the HPA 22, the controller 36 will open the release valve 32 to maintain wheel brake pressure P_{b} equal to demanded pressure P_{d}. Suitably, however, the controller 36 may also be programmed to anticipate the need to open the release valve 32 in this situation and begin to open the release valve 32 at the same time as the apply valve 24 is opened in order to minimize fluctuations in the wheel brake pressure P_{b}.

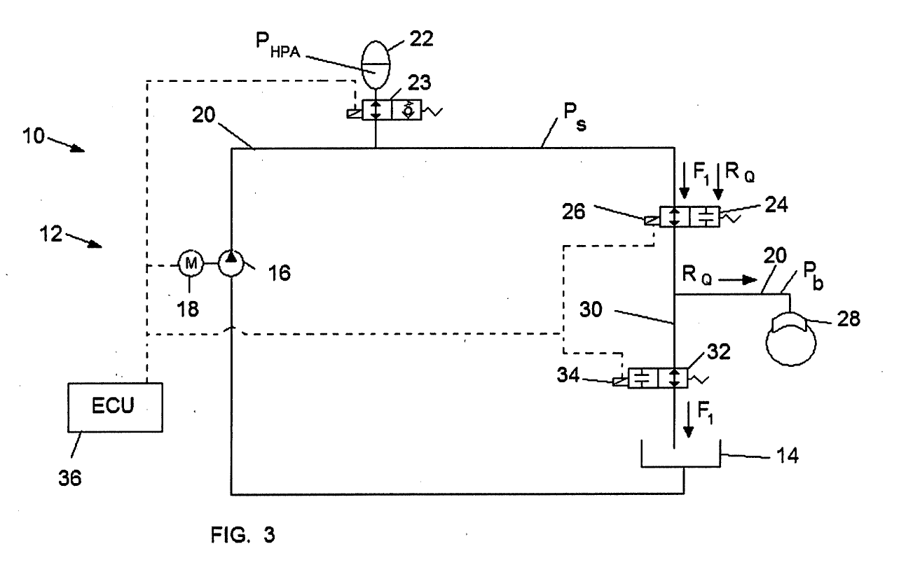

Next, referring to FIG. 3, consider a case where a braking signal is present, but the wheel brake pressure P_{b} is still being increased to equal the demanded brake pressure P_{d}. The apply valve 24 is open, and the release valve 32 is closed, with a brake fluid flow of R_{Q} flowing through the apply path into the wheel brake 28. If pressure in excess of Pₛₑₜ is determined to exist in the HPA 22, the HPA isolation valve 23 is opened to connect the HPA 22 to the conduit 20, if not already open as part of the braking operation. In order to relieve the excessive pressure in the conduit 20, that is, to reduce the supply pressure Pₛ in the conduit 20 to below the set-point pressure Pₛₑₜ, the apply valve 24 is opened further to permit an appropriate pressure relieving flow rate of brake fluid, F₁ in excess of the flow rate R_{Q} going to the wheel brake 28. As above, suitably the magnitude of the pressure relieving flow rate F₁ will increase dependent upon the degree to which the HPA pressure P_{HPA}, and thus the supply pressure Pₛ, exceeds the set-point pressure Pₛₑₜ. Simultaneously, the release valve 32 is opened sufficiently to pass the same flow rate F₁ of brake fluid through the release path that is flowing through the apply path. Since the flow rate through the release path is less than the flow rate through the apply path by an amount equal to R_{Q}, the flow rate into the wheel brake 28 remains equal to R_{Q}, and therefore the pressure P_{b} at the wheel brake 28 will continue to be brought up to the demanded brake pressure P_{d}.

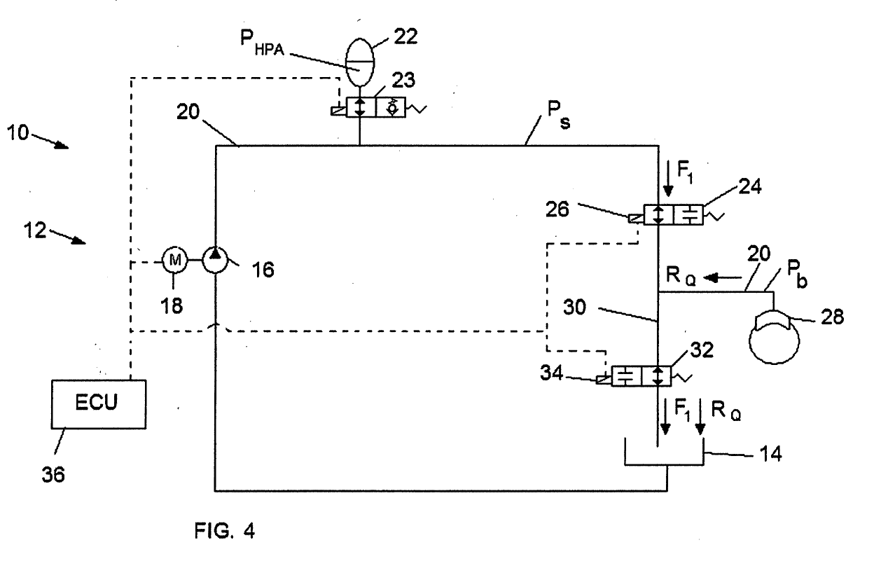

If the brake pressure P_{b} at the wheel brake 28 is being reduced at the time the over pressure condition is sensed in the HPA 22, then the apply valve 24 will be closed and the release valve 32 will be open to remove brake fluid from the wheel brake 28 at a rate R_{Q}. Referring now to FIG. 4, when pressure in excess Of Pₛₑₜ is determined to exist in the HPA 22 (or the conduit 20 upstream of the apply valve 24), the HPA isolation valve 23 is opened to connect the HPA 22 to the conduit 20. In order to relieve the excessive pressure in the conduit 20, the apply valve 24 is opened to permit an appropriate pressure relieving flow rate of brake fluid, F₁ to flow through the apply path to reduce the supply pressure Pₛ in the conduit 20 to below the set-point pressure Pₛₑₜ. Suitably the magnitude of the pressure relieving flow rate F₁ will increase dependent upon the degree to which the HPA pressure P_{HPA}, and thus the supply pressure P₅, exceeds the set-point pressure Pₛₑₜ. Simultaneously, the release valve 32 is further opened sufficiently to pass the flow rate F₁ in addition to the flow rate R_{Q} of brake fluid through the release path. Since the flow rate through the release path exceeds the flow rate through the apply path by an amount equal to the flow rate R_{Q}, the brake fluid continues to flow out of the wheel brake 28 at the rate R_{Q}. Therefore the pressure at the wheel brake 28 will continue to be reduced at the desired rate to bring the wheel brake pressure P_{b} down to the demanded brake pressure P_{d}.

Thus it will be appreciated that, when the EHB system 10 is operated according to the invention, the apply valve 24 and the release valve 32 can both be controlled to minimize the disruptions to the regulated wheel brake pressure, P_{b}, while simultaneously allowing excess fluid to flow into the reservoir 14. This is preferably done by maintaining the demanded brake pressure P_{d} so that the driver does not feel an additional or reduced braking force.

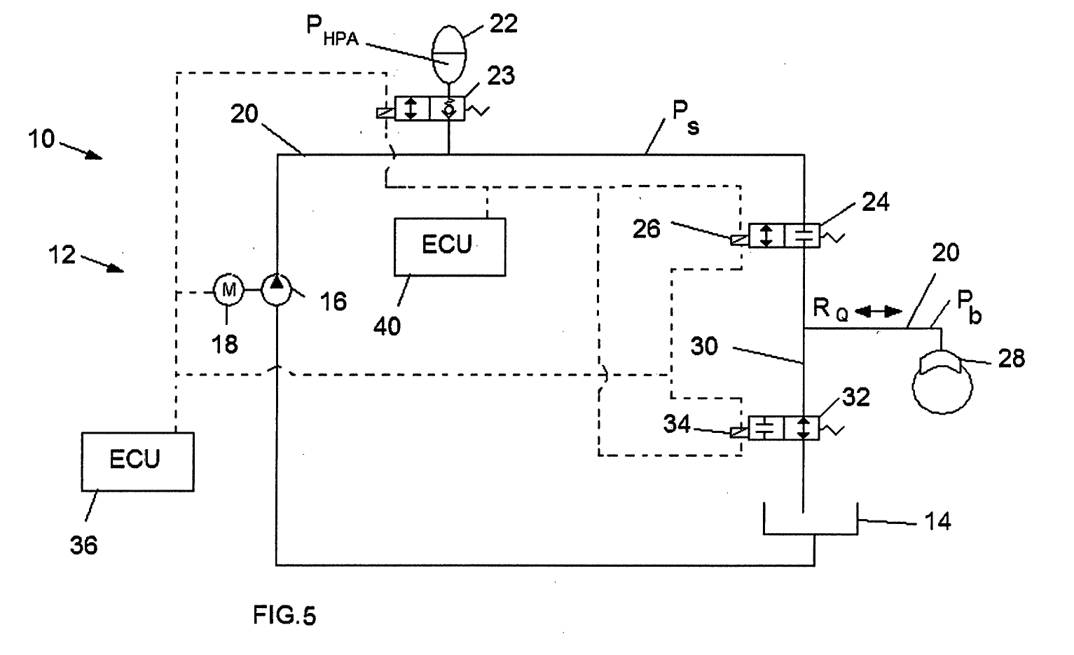

In an alternate embodiment, illustrated in FIG. 5, the apply valve 24 and the release valve 32 can have solenoids powered by different pressure control systems. One pressure control system (including the controller 36) could be used to regulate wheel brake pressure, P_{b}. The pressure at the wheel brake 28 is controlled by the EHB system 10 as described above. A second pressure control system, including a controller 40, monitors the HPA pressure P_{HPA} and the supply pressure Pₛ in the conduit upstream of the apply valve 24 used to prevent the HPA 22 (or the conduit 20 upstream of the apply valve 24) from being over-pressurized. The operation of the second system would be substantially as described above wherein the apply valve 24 and the release valve 32 can be moved between any combination of being opened and closed to control the excess flow that is causing an overpressure condition in the HPA 22 or conduit 20.

The two pressure control systems may operate under suitable system of control, such as current control or voltage control. For example, under a voltage control scheme, each of the controller 36 and the controller 40, can send additive voltage signals to the apply valve 24 and the release valve 32 such that the apply valve 24 and the release valve 32 respond to their combined signals. The combined operating signal from the two control systems is received by the solenoid 26 and the solenoid 34 of the apply valve 24 and the release valve 32, respectively, causing the apply valve 24 and the release valve 32 to respond accordingly.

It should be appreciated that the preferred embodiments described above are entirely related to modification of the electronic control strategy, and that the hydraulic system 12 does not need to be modified in any way to accommodate the described pressure relief functions, unless the embodiment illustrated in FIG. 5 with two controllers 36 and 40 is implemented, in which case, generally speaking, only the electrical components would differ. This is advantageous in that changes to the existing hydraulic subsystem are usually associated with increased manufacturing costs. For example, manufacturing valve springs for both the apply valve and the release valve, wherein the spring is dimensioned as a safety valve spring relieving excess pressure mechanically through the valves, requires additional machining and manufacturing costs due to, for example, tighter tolerances requirements to achieve consistent and reliable opening pressures.

Those of ordinary skill in the art will recognize that the invention may also be practiced with EHB systems having a system layout other than those disclosed in the '608 patent. It should also be understood that although only one wheel brake 28 (and one brake circuit 12) is shown in FIG. 1, in actual vehicle use the EHB system 10 shown can be implemented with a plurality of wheel brakes 28 (and braking circuits 12). Additionally, a control law implementing the pressure relief strategy algorithm, in accordance with the present invention, is preferably adapted to operate with, and is not limited to, multiple pressure command signals, gain schedules, linear controllers, switch logic circuits, valve table values, apply and release valves, pressure feedback sensors and pumps.

It can also be appreciated that in a vehicle, there typically are a plurality of wheels, each having independent wheel brakes 28. Thus, each brake circuit 12 would have a set of valves. Particularly, at least one pair of valves (an apply valve 24 and a release valve 32) is preferably used with each wheel and wheel brake 28. In such an arrangement, a controller 36 could control the valves 24, 32 for each wheel brake 28 separately. If it is necessary to increase the amount of flow from the HPA 22 in order to alleviate HPA pressure, the controller 36 can output a voltage signal to more than one apply valve 24 to further increase the flow from the HPA 22 through the apply valves 24. It may be advantageous to open more than one apply valve 24 to distribute the flow of hydraulic fluid from the HPA 22 throughout the entire vehicle braking system instead of through a single brake circuit 12. Typically, this distribution would be done to all four wheels, or to a pair of either the front or rear wheels (for a conventional passenger vehicle) to limit the disturbance felt by the driver. It should be appreciated that each valve could be opened different amounts so as to direct fluid flow through multiple brake circuits in disproportionate amounts. A multi-wheel distribution of the excess flow would minimize the effect on normal braking should an application of the brakes be necessary while the pressure relief strategy is activated.

As indicated above, sensor input to the controller 36 may include pump motor sensors (not shown). Such pump motor sensors may be embodied as sensors that look at, for example, back EMF in the motor power supply, motor amperage, pump flow rate, or other suitable indication of motor 18 or pump 16 operation. Such a sensor indicative of pump or motor operation can advantageously be an input to the control logic of the controller 36. The motor 18 will typically be signaled to run the pump 16 when the pressure P_{HPA} in the HPA 22 is below a desired turn-on set-point, and to stop running when the pressure P_{HPA} reaches a desired shut-off pressure set-point. Additionally, in order to improve system response, the motor 18 can be turned on in anticipation of pressure falling when, for example, a large braking demand signal is generated that can be anticipated in reducing the pressure P_{HPA} below the turn-on set-point even before the pressure P_{HPA} in the HPA 22 actually approaches the turn-on set-point.

In a failure condition, it is possible for the motor 18 to be running even if the pressure P_{HPA} in the HPA 22 is above the shut-off pressure set-point, for example, if there has been some sort of failure, such as a short circuit or bound relay. Utilizing the sensor or sensors discussed above to determine whether or not the pump 16 or the motor 18 is being operated when the pressure P_{HPA} is above the turn-off set-point will allow the controller 36 to anticipate continued pressure rise in the HPA 22. If it is determined that the pump 16 is running while the accumulator pressure P_{HPA} is above the pump shut-off pressure then a signal can be provided to the control logic of the controller 36 (or controller 40 of the embodiment illustrated in FIG. 5) to bias the apply valve 24 and the release valve 32 to rapidly open to a point in excess of that which would be demanded based on the pressure P_{HPA} in the HPA 22 alone, in anticipation of further pressure rise due to the pump 16 failing to shut off. Additionally, the controller 36 may additionally anticipatively open other apply valves and release valves (not shown) of the brake circuit 10 to provide additional pressure relief pathways therethrough in order to prevent excessive pressures being realized in the HPA 22 or the conduit 20.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope. For example, while the invention has been described using the example of a vehicle hydraulic brake system, and in particular an EHB system, the invention as described and claimed may suitably be practiced in various kinds of fluid systems including, without limitation, pneumatic vehicle brake systems, non-vehicular hydraulic and pneumatic brake systems, and hydraulic and pneumatic systems where pressure is controlled at a load which is not a brake actuator, but some other type of load on a fluid system, such as a fluid supply header, hydraulic motor, pneumatic actuator, etc.

1. A method of controlling pressure in a fluid system having a source of pressurized fluid for which a maximum desired fluid pressure value has been determined, a hydraulic load, an apply valve controlling pressurized fluid flow between said source and said load, and a release valve permitting fluid flow from said load to a low pressure reservoir, comprising:
controlling pressure at said hydraulic load by at least one of closing the release valve and opening the apply valve to increase pressure at said hydraulic load, and by at least one of closing said apply valve and opening said release valve to reduce pressure at said hydraulic load; and
limiting pressure of said source of pressurized fluid by opening both said apply valve and said release valve from the positions required to control pressure at said hydraulic load a sufficient amount to permit pressurized fluid from said source of pressurized fluid to flow through said apply valve and said release valve to said low pressure reservoir at a flow rate sufficient to limit pressure of said source of pressurized fluid to less than said maximum desired fluid pressure value.

2. A method for controlling the pressure in an electrohydraulic braking system having a pump, an accumulator and a valve arrangement controlling pressure at a vehicle brake, comprising the steps of:
sensing an accumulator pressure;
comparing the sensed accumulator pressure to a preset pressure set-point;
controlling at least one valve in the valve arrangement to allow fluid to flow through the valve if the sensed pressure at least equals the preset safety threshold pressure.

3. The method defined in claim 2 further comprising the step:
controlling an apply valve in the valve arrangement to allow excess fluid in the accumulator to flow out of the accumulator if the sensed accumulator pressure at least equals the preset pressure set-point.

4. The method defined in claim 3 further comprising the step:
controlling a release valve in the valve arrangement to allow excess fluid to flow into a reservoir if the sensed pressure at least equals the preset pressure set-point and a pressure at a vehicle brake is above a demanded pressure.

5. The method defined in claim 2 further comprising the steps:
determining that the pump is running while accumulator pressure is above the pump shut-off pressure; and
providing a signal to bias the at least one valve to rapidly open to a point in excess of that which would be demanded based on accumulator pressure alone in anticipation of further pressure rise due to the pump failing to shut off.

6. The method defined in claim 5 further comprising the step:
acting in a first manner if the accumulator pressure at least equals the preset pressure set-point with the pump being off; and
acting in a second manner if the accumulator pressure at least equals the preset pressure set-point with the pump being on.

7. The method defined in claim 6 wherein the first manner of acting comprises opening the apply and release valves a first amount of opening to allow flow therethrough;
the second manner of acting comprises anticipatively opening the apply valves a second amount of opening, greater than said first amount of opening, to allow flow therethrough.

8. The method defined in claim 6 wherein the first manner of acting comprises opening the apply and release valves a first amount of opening to allow flow therethrough; and
the second manner of acting comprises anticipatively opening additional apply and release valves to allow flow therethrough.

9. A method of controlling pressure in an electrohydraulic braking system having a source of pressurized fluid for which a maximum desired fluid pressure value has been determined, at least one hydraulically operated brake, an apply valve associated with the at least one brake for controlling pressurized fluid flow between the source and the at least one brake, and a release valve associated with the at least one brake for controlling fluid flow from the at least one brake to a low pressure reservoir, comprising:
controlling pressure at the at least one brake by at least one of closing the associated release valve and opening the associated apply valve to increase pressure at the at least one brake, closing the associated apply valve and opening the associated release valve to reduce pressure at the at least one brake, and closing both the associated apply valve and the associated release valve to hold pressure at the at least one brake; and
controlling pressure of the source of pressurized fluid by simultaneously opening both the associated apply valve and the associated release valve from the positions required to control pressure at the at least one brake a sufficient amount to permit pressurized fluid from the source of pressurized fluid to flow through the associated apply valve and the associated release valve to the low pressure reservoir to lower pressure at the source of pressurized fluid.

10. The method of controlling pressure in an electrohydraulic braking system defined in claim 9, further including controlling pressure of the source of pressurized fluid by simultaneously opening both a second apply valve and a second release valve from the positions required to control pressure at a respective second brake a sufficient amount to permit pressurized fluid from the source of pressurized fluid to flow through the second apply valve and the second release valve to the low pressure reservoir to lower pressure at the source of pressurized fluid while simultaneously continuing to control pressure at the respective second brake to a desired pressure.

11. The method of controlling pressure in an electrohydraulic braking system defined in claim 9 wherein the operation of controlling pressure at the at least one brake is performed by a first electronic control unit, and the operation of controlling pressure of the source of pressurized fluid is controlled by a second electronic control unit.

12. The method of controlling pressure in an electrohydraulic braking system defined in claim 9 wherein the operation of controlling pressure at the at least one brake and the operation of controlling pressure of the source of pressurized fluid is controlled by a single electronic control unit.

13. The method of controlling pressure in an electrohydraulic braking system defined in claim 9 wherein the source of pressurized fluid includes a motor-driven pump, operation of at least one of the motor and the pump being sensed and provided as input to a controller controlling operation of the apply valve and the release valve.

14. The method of controlling pressure in an electrohydraulic braking system defined in claim 13 wherein the input to the controller indicating operation at least one of the motor and the pump is an input to an anticipative function which biases the apply valve and the release valve toward a more open initial position than would be assumed based on solely the difference between a pressure of the fluid supplied by the source of pressurized fluid and a pressure relief set-point when operation of the at least one of the motor and the pump is sensed and the pressure of the fluid supplied by the source of pressurized fluid is above a desired pump shut-off set-point.

15. The method of controlling pressure in an electrohydraulic braking system defined in claim 13 wherein the braking system includes a second apply valve and a second release valve operating at respective initial positions to control pressure at a respective second brake, the anticipative function additionally opening both the second apply valve and the second release valve toward respective positions more open than their respective initial positions point when the pressure of the fluid supplied by the source of pressurized fluid is above a pressure relief set-point and operation of the at least one of the motor and the pump is sensed and the pressure of the fluid supplied by the source of pressurized fluid is above the desired pump shut-off set-point.

16. The method of controlling pressure in an electrohydraulic braking system defined in claim 15 wherein the anticipative function biases both the second apply valve and the second release valve toward respective positions more open than the positions that would be assumed based on solely the difference between the pressure of the fluid supplied by the source of pressurized fluid and the pressure relief set-point.

17. The method of controlling pressure in an electrohydraulic braking system defined in claim 9 wherein the braking system includes a second apply valve and a second release valve operating at respective initial positions to control pressure at a respective second brake, the method further including controlling pressure of the source of pressurized fluid by additionally simultaneously opening both the second apply valve and the second release valve from the positions required to control pressure at the respective second brake a sufficient amount to permit additional pressurized fluid from the source of pressurized fluid to flow through the second apply valve and the second release valve to the low pressure reservoir to lower pressure at the source of pressurized fluid.
